(19) United States
(12) Patent Application Publication
(10) Pub. No.: US 2011/0227928 A1
(43) Pub. Date: Sep. 22, 2011

(54) Online Barcode Directory and Systems for Facilitating Transactions Utilizing the Same

(76) Inventors: Jay Ungos, Laguna Niguel, CA (US); Orlando G. Ungos, Burbank, CA (US)

(21) Appl. No.: 12/816,146

(22) Filed: Jun. 15, 2010

Related U.S. Application Data
(63) Continuation-in-part of application No. 12/750,399, filed on Mar. 30, 2010.
(60) Provisional application No. 61/314,687, filed on Mar. 17, 2010.

(51) Int. Cl. G06T 11/20; G06K 19/06

(52) U.S. Cl. 345/441; 235/494

(57) ABSTRACT

An online directory of people, businesses and products which is accessible by a user is described herein. Each person, business or product may be associated with a unique visual identifier such as a barcode which facilitates transactions between the parties. Moreover, the barcode may be an electronic barcode which can be displayed on a user's phone and scanned by a camera of the other party's electronic system. It is contemplated that the electronic barcode may be displayed only after entering a password on the user's mobile phone.

### CROSS-REFERENCE TO RELATED APPLICATIONS

The present application is a continuation in part application of U.S. patent application Ser. No. 12/750,399, filed Mar. 30, 2010, which claims the benefit of U.S. Pat. App. Ser. No. 61/314,687, filed on Mar. 17, 2010 the entire contents of which are expressly incorporated herein by reference.

### STATEMENT RE: FEDERALLY SPONSORED RESEARCH/DEVELOPMENT

Not Applicable

### BACKGROUND

The present invention relates to a directory of people, businesses and products associated with a unique visual identifier (e.g., barcode) and a method for facilitating transactions between consumers and businesses.

Online directories of businesses and people provide a useful function to society looking for any particular person or business. These online directories provide a search box in which a user may type in an alphanumeric word or phrase in order to look for a particular individual or business. Upon searching the online directory, the online directory returns a list of search results that may contain the exact string of alphanumeric characters and/or similar characters compared to the searched alphanumeric word or phrase. Unfortunately, the user must now sift through each of the references to determine whether the user has located the intended individual or business. In many instances, based solely on the alphanumeric word or phrase, the user is unable to verify that the located individual or business is the actual individual or business that the user intended to find. The user must confirm through a secondary source such as directly calling the individual or business to confirm or verify the address of the individual or business provided that the user has the individual's or business's address. Unfortunately, searching online directories is a less than accurate and efficient search.

Reward cards for various stores such as Ralph's, etc. are prolific in various retail segments. In order to sign up for these cards, the user must provide the store with his/her contact information, namely, name, address, telephone number and e-mail address. The store provides the user with a small card that he/she can attach to his/her keychain. The user by being a member of the store's reward program may take advantage of various discounts throughout the store. The store tracks the user's purchasing behavior for various reasons. Unfortunately, the user must carry and present a small card that the store provides in order to take advantage of the various discounts throughout the store. Stores may also enable the user to punch in a unique identifying number such as a telephone number in lieu of scanning the rewards card which may have a barcode attached to its backside. Unfortunately, in signing up for various rewards programs, the user must now carry a number of reward cards which may prove cumbersome, aesthetically displeasing, etc.

Accordingly, there is a need in the art for an improved online directory and method of transacting business between people and businesses such as in the rewards program context.

### BRIEF SUMMARY

A barcode server may comprise a list of people, businesses and products. For each person, business and product, a barcode server may associate a unique visual identifier. The barcode server may be accessible by way of a communication link such as the internet, landline or other communication means known in the art or developed in the future.

In a first aspect, the barcode server may serve as an online directory of people, businesses and products. The barcode server may be accessible by way of a website which can provide a user the means for alphanumerically searching the list of people, businesses and products. Additionally, the website may also allow the user to search the online directory store on the barcode server by way of the unique visual identifier of a particular person, business or product. By way of example and not limitation, the user may obtain the unique visual identifier of a particular person, business or product at a tradeshow, mall, etc. The person or business may provide the user with a business card or brochure with a barcode displayed thereon. The user may retain the brochure or business card with the barcode. The user may at a later time, scan the barcode with the user's camera mounted to the user's laptop, desktop or mobile phone. Upon scanning the barcode, the website serves up a webpage of a particular person, business or product. Unlike personal names, business names and trademarks, the barcode is unique to each person, business or product. As such, the served up webpage is the webpage that the user intended to look for. Accordingly, the barcode server aids in transacting information between people, businesses and products.

In another aspect, the barcode server may facilitate a rewards program among various businesses. Each person with a unique visual identifier may sign up with a business's reward program. For example, the person may authorize the business to access certain information on the barcode server. In order to utilize the rewards program, the person when purchasing product at the business may scan his/her unique visual identifier with the business's point of sale system. For example, the person may electronically display his/her unique visual identifier on the user's mobile phone. The unique visual identifier of the person may be displayed after depressing a sequence of buttons. Moreover, it is contemplated for added security that the user's unique visual identifier is displayed only after entering a password or code into the mobile phone. The user scans his/her barcode with the business's point of sale system. The point of sale system may transmit the transaction to the barcode server that analyzes the data and returns information back to the business so as to appropriately apply a discount, send discount e-mails or discount mailings to the user. The user has only one unique visual identifier which works across various businesses which is tied into the barcode server.

In another aspect, the unique visual identifier may be utilized to facilitate monetary transactions between the user and a business. The user may purchase product from the business by displaying the unique visual identifier on the user's mobile phone. The unique visual identifier may be displayed on the user's mobile phone only after entering a password or code. The point of sale system of the business scans the user's unique visual identifier and transmits the information to the barcode server. The barcode server records the transaction and sends the information to the various appropriate banks, and other entities to complete transaction.

In another aspect, the unique visual identifier may be utilized to streamline medical processes. In particular, medical information on a person may be stored on the barcode server 18. Access to the medical information stored on the barcode server 18 may be authorized by the person by allowing a business such as a doctor to scan the person's unique visual identifier (e.g., barcode) then providing the business or doctor with authorization to access the medical information of the person. For example, the person may punch in a password after the doctor scans his/her unique visual identifier to enable the doctor to have access to the person's medical information stored on the barcode server 18.

More particularly, a method for facilitating a transaction between a plurality of first entities and a second entity is disclosed. The method may comprise the steps of scanning an electronically displayable unique visual identifier associated with one of the plurality of first entities during the transaction; transmitting information related to the one of the first entities and a unique identifier of the second entity to a service provider to record the transaction, the service provider having a first list of first entities and a second list of a plurality of second entities; and receiving confirmation from the service provider that the transaction has been recorded.

The method may further comprise the step receiving statistics regarding transaction behavior of the one of the plurality of first entities so that the second entity applies an appropriate reward to the transaction or the second entity sends an appropriate reward offer to the one of the plurality of first entities for a subsequent transaction. Also, the method may further comprise the step of instructing the service provider to send an appropriate reward offer to the one of the plurality of first entities based on the recorded transactions of the one of the plurality of first entities. Moreover, the method may further comprise the step of receiving information from the one of the plurality of first entities regarding which piece of information stored with the service provider to use in relation to the transaction. The piece of information may be related to one of a plurality of credit cards stored with the service provider. The unique visual identifier may be an electronically displayable barcode.

Additionally, a method for facilitating a transaction between a plurality of first entities and a plurality of second entities is disclosed. The method may comprise the steps of receiving information related to a unique visual identifier of one of the plurality of first entities and a unique identifier of one of the plurality of second entities; recording a transaction based on the received information; and sending a reward or a reward offer to the one of the plurality of first entities based on the recorded transaction.

The method may further comprise the step of compiling a list of first entities and a list of second entities, each first entity associated with a unique visual identifier and each second entity associated with a unique identifier.

Moreover, a method of purchasing product from a business by a purchaser is disclosed. The method may comprise the steps of selecting the product to be purchased at the business; depressing a series of buttons on a mobile phone to electronically display a unique visual identifier associated only with the purchaser; disposing the electronically displayed unique visual identifier in front of a scanner of a point of sale system of the business; selecting a payment mode with the point of sale system of the business; and deactivating the electronically displayed unique visual identifier after the point of sale system of the business has scanned the electronically displayed unique visual identifier for security purposes.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a diagram of inter relationships between people, businesses, products and a barcode server;

FIG. 2 is an illustration of a website for searching the barcode server;

FIG. 3 illustrates scanning of a barcode displayed on an electronic display of a mobile phone; and

FIG. 4 illustrates scanning a barcode by way of a camera of a mobile phone.

### DETAILED DESCRIPTION

Referring now to the drawings, a directory of people 10, businesses 12 and products 14 may be provided wherein each person 10, business 12 and products 14 may be associated with a unique barcode 16. The directory of people 10, businesses 12 and products 14 may be stored on a barcode server 18 which can be accessed by way of the internet 20. Each person 10, business 12 and product 14 may have other information associated with the person 10, business 12 and product 14 and stored on the barcode server 18.

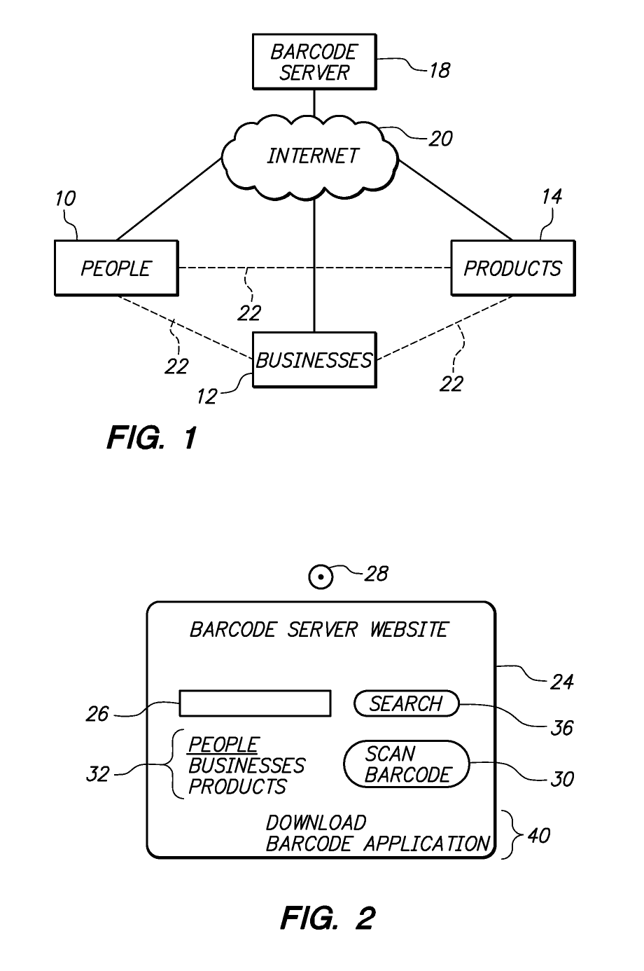

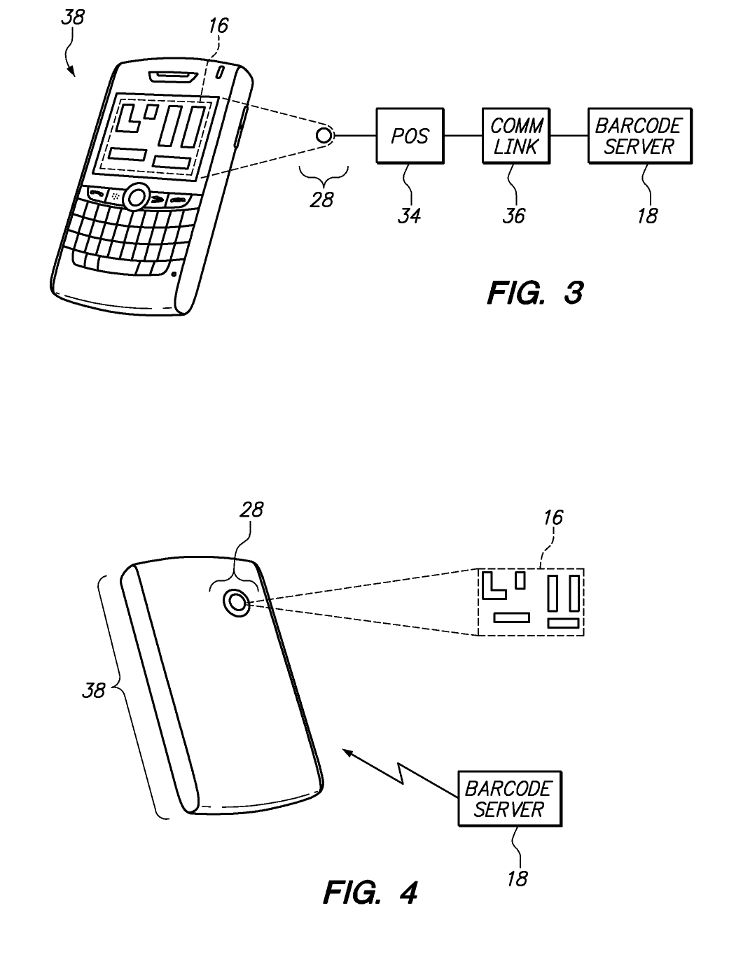

The barcode server 18 and the information stored on the barcode server 18 may facilitate information transfer 22 between people 10, business 12 and products 14 as shown by the dash lines 22 in FIG. 1. By way of example and not limitation, users may access the barcode server 18 through a barcode website 24 (see FIG. 2) wherein the user may search for people 10, business 12 and products 14 alphanumerically by way of the search box 26. If the alphanumeric search box 26 is used, then the website 24 may provide a listing of potentially relevant people 10, businesses 12 and products 14. The toggle area 32 may be selected to narrow the search to only people, businesses or products. The user may click through to any one particular person 10, business 12 or product 14 to find additional information regarding the same. Alternatively, the user may conduct a barcode search by scanning a unique barcode 16 associated with a person, business or product with a computer's camera 28. By way of example and not limitation, the user may hold a business card with a barcode affixed thereto in front of the computer's camera 28 and depress the scan barcode button 30. A webpage associate with the barcode 16 may be retrieved.

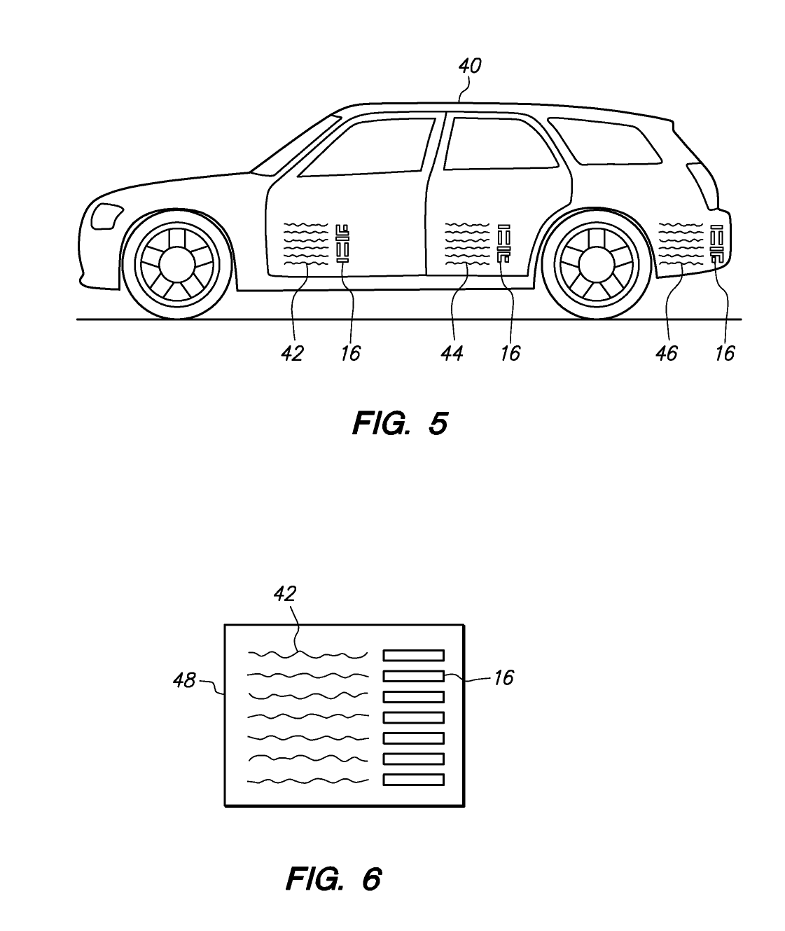

Another example of a transaction facilitated by the barcode server 18 is one between a person 10 and a business 12. The person 10 may purchase a product 14 sold by the business 12. Upon checkout, the business 12 may request the person 10 to display his/her barcode 16 so that the person 10 may record the transaction in the business's reward program. The business 12 may scan the person's barcode 16 as shown in FIG. 3 by way of a camera 28 located at the business's point of sale system 34. The point of sale system 34 communicates with the barcode server 18 by way of a communication link 36 (e.g., internet, etc.) to record the transaction as well as apply any applicable discounts, send out any applicable reward offers to the person 10, etc.

More particularly, referring now to FIG. 1, businesses 12 and people 10 may access the barcode server 18 by way of a communication link such as the internet 20. People 10 may request that a barcode (more broadly, a unique visual identifier) be associated with him/her. The barcode server 18 may transmit the unique visual identifier or barcode to the person. This barcode or unique visual identifier is only associated with this person. The person 10 may affix the barcode on his/her personal card, website, avatar or cell phone display. The person 10 may also associate various types of information with his/her unique visual identifier 16 on the barcode server such as contact information, buying preferences, credit card information, resume, etc. by logging on to the barcode server 18. The person 10 may make some of the information private so that only the person and authorized entities can access such information. Also, the person may make some of the information public such that the public information may be retrievable by anyone. Other levels of privacy are also contemplated.

Likewise, businesses 12 may also request the barcode server 18 to associate a barcode 16 with the business 12. A business 12 may logon to the barcode server 18 to add further information about the business 12. By way of example and not limitation, the business 12 may include information such as contact information, business hours, current promotions, website address, etc. This information may be made public such that anyone may retrieve such public information by way of the internet 20. Also, the business 12 may include private information on the barcode server 18 such as credit card information, etc. Additionally, businesses 12 may list various products 14 that they offer for sale on the barcode server 18. To this end, the business 12 may request additional barcodes 16 for each of the products 14 that they sell. For each of the products 14, the business 12 may associate product information that may be retrievable by the general public. By way of example and not limitation, the product information may include MSRP, retail stores where product is sold, customer reviews, etc.

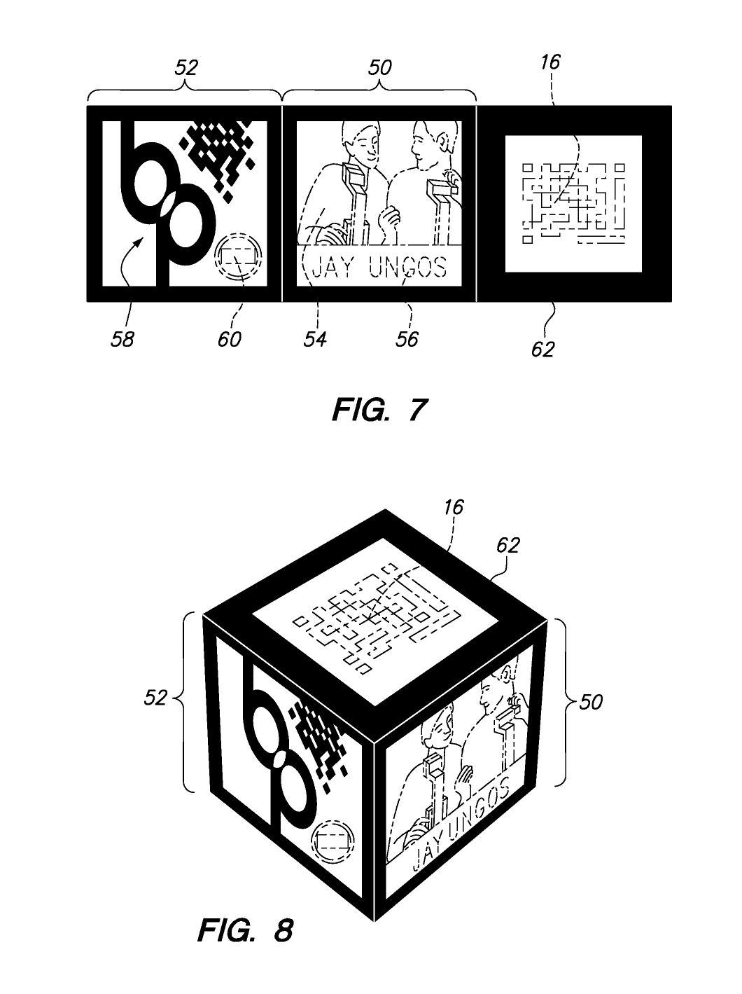

The barcode 16 may more broadly be referred to as a unique visual identifier. Preferably, the unique visual identifier is optically scannable by way of a camera phone 28 as shown in FIG. 4, point of sale camera 28 as shown in FIG. 3, or a computer camera 28 as shown in FIG. 2. The unique visual identifier 16 may be a one dimensional barcode, two dimensional barcode or a three dimensional barcode. The illustration of the barcode 16 shown in FIGS. 3 and 4 is that of a two dimensional barcode. Other types of unique visual identifiers are also contemplated to the extent that they are optically scannable.

Referring now to FIG. 2, the barcode server 18 may be accessible by a website 24. The website 24 may have one or more different options for searching the information on the people 10, businesses 12 and the products 14 stored on the barcode server 18. By way of example and not limitation, the website 24 may have an alphanumeric search box 26. A user may enter a name of a person 10, a name of a business 12 or a name of a product 14 or other relevant information into the alphanumeric search box 26. The user may click on the search button 36 which triggers the barcode server 18 to query its database and return a list of people 10, businesses 12, and products 14 having the same or similar alphanumeric sequence. The search results may be a hyperlink to the webpage of the person 10, business 12 or product 14 stored on the barcode server 18 or a different server. The webpage may display information regarding the person 10, business 12 and/or product 14 including but not limited to the barcode 16 itself. The user may limit the search to people 10, businesses 12 or products 14 by toggling one of the links or buttons 32.

Alternatively, a user may search the barcode server 18 with a barcode 16. By way of example and not limitation, the user may receive a business card, for example, from a potential service provider. The business card may have the service provider's business name and contact information but may also include the service provider's unique barcode 16. If the user utilizes the alphanumeric search box 26 to search for this business 12 or person 10, the search results would list multiple names identical or similar to the source provider he/she is trying to find. The user must sift through the search results to identify or locate the particular person 10 or business 12 that the user is attempting to locate. In contrast, when the user scans the service provider's unique barcode 16 on the business card, the service provider's particular webpage is returned. To conduct the search by the barcode 16, the user places the barcode 16 on the business card in front of the camera 28. While the barcode image is in the field of view of the camera 28, the user may click on the scan barcode button 30. The camera 28 captures the barcode image. The barcode image is transmitted to the barcode server 18 and serves up the particular webpage of the person 10 or business 12. The same may also be true for products 14. By way of example and not limitation, a pedestrian may be walking through a mall wherein various product brochures and cards may be given to the user. The brochures and product cards may have its barcode 16 printed thereon. The user may utilize the website 24 shown in FIG. 2 to search for more information regarding the product 14 by utilizing the scan barcode function described herein. When the barcode 16 of a particular person 10, business 12 or product 14 is scanned, the barcode server 18 may serve back a particular webpage as selected by the person 10 or the business 12 associated with the scanned barcode 16.

The scan barcode function described above may also be accomplished by a mobile phone 38. The barcode server 18 may wirelessly transmit a barcode applet to the mobile phone 38 of a user. The barcode server 18 may be activated or triggered to transmit such barcode applet wirelessly or through a landline. By way of example and not limitation, the user or owner of the mobile phone 38 may go to the webpage 24 and click on the download barcode applet 40. The download barcode applet link may either immediately download the barcode applet or alternatively, an email may be sent to the user's mobile phone 38 which provides a link so that the user's mobile phone 38 can retrieve the barcode application and install the same on the mobile phone 38 by clicking on the link. The barcode application enables utilization of the scan barcode function described herein. Once the barcode application is installed on the mobile phone 38, the user may access the barcode application. Upon startup of the barcode application, the camera 28 of the mobile phone 38 is operative to scan the barcode 16 or other unique visual identifier. The barcode 16 may be affixed to a business card, a store front, product 14, or any other location associated with a particular product 14, business 12 or person 10. When the mobile phone 38 scans the barcode 16, the barcode application may retrieve a particular webpage associated with the barcode 16. It is also contemplated that whether the barcode 16 is scanned by an internet enabled mobile phone, a desktop computer, laptop computer, etc., scanning of the barcode 16 may trigger one of many different events. In the context described above, scanning of the barcode 16 returned a particular webpage. However, other events are also contemplated such as transmission of a text message, email, launch of an application, etc.

Referring now to FIGS. 1 and 3, the barcode server 18 may also run a rewards program. By way of example and not limitation, the user when making a purchase at a store may be requested to display his/her unique visual identifier 16. The user may retrieve his/her unique visual identifier as shown in FIG. 3 and allow the store to scan his/her unique visual identifier 16. The user may punch in a password which displays the barcode 16 on the electronic screen of the user's mobile phone. The store may have a camera 28 that scans the unique visual identifier 16 and transmits the same to the barcode server 18. The store may have a point of sale system 34 which captures and transmits the unique visual identifier 16 of the purchaser along with a record of the transaction between the store and the purchaser to the barcode server 18. The barcode server 18 records the transaction and may provide a summary report to the store in periodic intervals regarding its customers purchasing patterns. Additionally, in real time, the barcode server 18 may resend a discount coupon to the point of sale system 34 so that the store may apply a discount to the user's purchase to reward the user of his/her loyalty to the store. The user's unique visual identifier 16 may be linked to multiple reward programs of various businesses 12 so that the user no longer needs to carry a plurality of reward cards in order to obtain discounts and other preferential treatment from the store. The consumer's unique visual identifier (e.g., barcode) is linked to multiple rewards programs. The barcode server 18 may additionally be programmed to send discount mailings or electronic discount mailings to the user 16 based on the user's purchasing patterns. Additionally, electronic discounts or mailed discounts may be sent to the user based on the user's loyalty to one particular store or combination of stores. The barcode server 18 may provide statistics to the store about its customers purchasing patterns so that the store may also send coupons or reward offers electronically or by direct mail to the user or purchaser. One of many benefits of the user's unique visual identifier 16 is in its security. The user must activate the visual identifier 16 by physically pressing buttons (e.g., generic key sequence or password) on the mobile phone 38 in order to retrieve the unique visual identifier 16. Anonymous bystanders may not deceptively activate or display the unique visual identifier located on the mobile phone 38 so as to steal the barcode 16. Also, the user may associate a single barcode 16 with a plurality of reward programs of various businesses 12. In this manner, the user need not carry a plurality of reward cards on his/her keychain.

Additionally, in a further type of transaction between a person 10 and a business 12, the person 10 may utilize the barcode 16 to purchase products 14 and/or services from the business 12. In particular, upon checkout, the business 12 may request that the user scan his/her barcode 16 to the businesses camera 28. The user retrieves the barcode 16 which may be retrieved only by way of a password protect system on the mobile phone 38. Upon display of the barcode 16 on the display of the mobile phone 38, the user places the barcode 16 in front of the camera 28 of the business's point of sale system 34. Upon scanning of the barcode 16, the point of sale system 34 requests the user to specify which type of payment the user is authorizing. By way of example and not limitation, the user may authorize a bank withdrawal, a credit card charge, etc. Once the user enters this information, the transaction including but not limited to the unique visual identifier 16, the type of charge being authorized, the amount of the charge, etc. related to the transaction may be sent to the barcode server 18 by way of the communication link 34 (e.g., internet). This step may be password protected so that the transaction does not go through unless the user punches in the correct password into the point of sale system 34. The barcode server 18 may process the payment transaction and notify the business's point of sale system 34 that payment has been received. The barcode server 18 transfers funds accordingly to the business's account.

In a further aspect, the barcode server 18 may store medical information. The medical information about a particular person 10 may be specifically stored on the barcode server 18 and associated with that person's barcode server account. A business 12 such as a doctor's office may be given permission to add, delete and/or modify the person's medical information on the barcode server 18. The doctor's office 12 accesses the person's account on the barcode server 18 through a communication link such as the internet 20. During use, the person may consult a first doctor for a particular health issue. The first doctor may scan the person's unique visual identifier 16 by way of camera 28 at the doctor's office or point of sale system 34. This may provide the doctor's office 12 authorization to access the person's medical information on the person's barcode server account. Alternatively, it may be required that the person enter in a password into the doctor's point of sale system 34 after scanning the person's unique visual identifier 16. If the person 10 is dissatisfied with the first doctor or moves to a different city or state, the person 10 must see a second doctor for the health issue. Instead of requesting that the files of the first doctor be transferred to the second doctor as is necessary in a paper based medical office, the second doctor may scan the person's unique visual identifier 16 and be provided access to the person's medical information stored on the barcode server 18. In this manner, the medical process is streamlined and medical records are provided to the current doctor without having to wait for transfer of paper files. The medical information on a person is stored on the barcode server 18 centrally. The person 10 allows one or more doctors authorization to view, modify, add or delete such medical information. This process streamlines the process and provides the doctor with up to date information on the patient's health condition.

Referring now to FIG. 5, in a different aspect, the unique visual identifier may be placed on an exterior surface of an automobile 40. By way of example and not limitation, a company name 42, slogan 44 or other advertisement 46 may be disposed on the exterior surface of the automobile 40. A unique visual identifier 16 such as a barcode may be closely associated with each of the company name 42, slogan 44 or other advertisement 46. When the automobile 40 is parked, individuals seeing the automobile 40 may approach the automobile 40 and scan a desired unique visual identifier 16 with his/her mobile phone 38. Upon scanning the unique visual identifier 16, the barcode server 18 may serve up a webpage, text message or other action to the person's designated email address or mobile phone 38. The company name 42, slogan 44 or advertisement 46 along with the associated unique visual identifier 16 may be screen printed on the exterior surface of the automobile 40, provided in a sticker format or other means known in the art.

Referring now to FIG. 6, the unique visual identifier 16 may be associated with a company name 42 listed on a directory 48. By way of example and not limitation, at shopping malls throughout the United States, there may be a directory 48 located at a central location or entrance areas to the shopping mall. The directory 48 may provide a map along with a listing of stores located at the shopping mall. The directory 48 may have a listing of names 42. Alongside the listing of names 42, a unique visual identifier 16 may be associated with each other company named 42. When a shopper finds a store, the shopper may scan the unique visual identifier 16 with his/her mobile phone 38. Upon scanning the unique visual identifier 16, the mobile phone 38 may transmit a signal to the barcode server 18. The barcode server 18 may then serve up a webpage, text message, etc. to provide the shopper with additional information. By way of example and not limitation, the barcode server 18 may serve up to a shopper current sales, discounts, directions, store hours, etc.

It is contemplated that scanning of the unique visual identifier 16 may trigger one of many different events. By way of example and not limitation, scanning a barcode may trigger a text message, serving up a webpage, start up of a flash program, etc. The person 10 or business 12 associated with the barcode or unique visual identifier 16 may program the barcode server 18 to trigger the desired event.

Referring now to FIG. 7, the barcode 16 may be disposed adjacent to one or more visual identifiers 50, 52. When the barcode 16 is shown by itself, it is unclear what the barcode 16 represents. A device such as a barcode scanner is required to scan the barcode 16 to find out what information is represented by the barcode 16. The visual identifiers 50, 52 enable a person to figure out what type of information is represented or associated with the barcode 16 without a barcode scanner. By way of example and not limitation, the visual identifier 50 may be located adjacent the barcode 16. The visual identifier 50 may include a picture 54 of a person when the barcode 16 relates to information regarding the person shown in the picture 54. Moreover, the visual identifier 50 may also include a name 56 of the person associated with the barcode 16. The visual identifier 52 may include a logo 58 of the type of barcode 16. Adjacent the logo 58, an icon 60 representing the type of information associated with the barcode 16 may be displayed. In this example, the icon 60 may represent a person. In this example, the barcode 16 is related to a person. The barcode 16 may relate to other things such as a place, a thing, an event, etc. For each of these scenarios, the icon 60, picture 54, and name 56 may be changed to represent the type of information associated with the barcode 16. For example, if the barcode 16 represents a place, then the picture 54 may be replaced with a picture of the place, the name 56 may be replaced with the name of the place, and the icon 60 may be replaced with a generic depiction (i.e., icon) of a place.

Referring now to FIG. 8, the barcode 16 and the various visual identifiers 50, 52 may have other arrangements. The arrangement shown in FIG. 8 shows the barcode 16 and the visual identifiers 50, 52 arranged in a cubelike representation. Other configurations are also contemplated. The barcode 16 may be presented alongside one or both of the visual identifiers 50, 52 in order to provide a visual context that can be deciphered by a person without the use of a specialized barcode reading device.

The barcode 16, visual identifiers 50, 52 may share a common border 62. The common border 62 shown in FIGS. 7 and 8 provide three separate sections for the barcode 16, first visual identifier 50 and second visual identifier 52. However, it is also contemplated that the common border 62 provide for a single area that displays the barcode 16, first visual identifier 50 and/or the second visual identifier 52. Nonetheless, the barcode 16 and at least one of the icons 60, visual depiction 54 and name 56 is enclosed within a common border 62. The logo 58 may also be included in the common border 62.

The above description is given by way of example, and not limitation. Given the above disclosure, one skilled in the art could devise variations that are within the scope and spirit of the invention disclosed herein, including various ways of retrieving the unique visual identifier. Further, the various features of the embodiments disclosed herein can be used alone, or in varying combinations with each other and are not intended to be limited to the specific combination described herein. Thus, the scope of the claims is not to be limited by the illustrated embodiments.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. A method of providing visual reference regarding a barcode to a person, the method comprising the steps of:
presenting barcode indicia to the person;
adjacent to the barcode indicia, presenting a first visual identifier adjacent to the barcode indicia wherein the first visual identifier includes a name, visual depiction, icon or a combination thereof for providing the visual references to the person;
enclosing the barcode indicia and first visual identifier within a common border.

14. The method of claim 13 wherein the visual depiction is a photograph.

15. The method of claim 13 wherein the icon is a person, place, product or event.

16. The method of claim 13 wherein the barcode indicia and the first visual identifier are presented horizontally adjacent to each other.

17. The method of claim 13 further comprising the step of presenting a barcode type of indicia adjacent to the barcode indicia.

18. The method of claim 13 wherein the barcode type indicia is a logo.
